(19) United States
(12) Patent Application Publication
(10) Pub. No.: US 2007/0139943 A1
(43) Pub. Date: Jun. 21, 2007

(54) AN ILLUMINABLE FEATURE MODULE FOR INSTALLING IN A CONSOLE

(75) Inventors: Jason Bone, Pontiac, MI (US); Scott Moyer, Fraser, MI (US)

Correspondence Address: ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 11/306,265

(22) Filed: Dec. 21, 2005

(51) Int. Cl. B60Q 3/02; F21V 23/04

(52) U.S. Cl. 362/488; 362/295; 362/85

(57) ABSTRACT

An illuminable feature module for installing in a console is disclosed herein. The feature module includes an installable mount, a feature, a power inverter, and an illuminable electroluminescent wire. The feature is joined to the mount, and the power inverter is attached to the mount. The power inverter has both a power input and a power output. The electroluminescent wire is electrically connected to the power output of the power inverter. The electroluminescent wire is also fixedly arranged about the feature for thereby illuminating the feature. The mount, together with the feature, power inverter, and electroluminescent wire, is installable in a console.

### FIELD OF THE INVENTION

The present invention generally relates to console assemblies and more particularly relates to the installation of illuminable features in such assemblies.

### BACKGROUND OF THE INVENTION

When traveling in the dark at night, a driver has sometimes found it difficult to access or make use of a feature within the floor console of his vehicle because of insufficient lighting in the vehicle's cabin. Though the driver may turn on the overhead dome light within his vehicle to better see the floor console, such is not preferable, for the dome light's reflection on the front windshield at night may interfere with the driver's road vision.

To remedy the problem, some automobile manufacturers have incorporated small light bulbs within the floor consoles of their vehicles. In this way, when their vehicles are driven at night, each light bulb provides a continual low-level light source about a floor console without interfering with a driver's vision. Over time, however, the use of such lights has been deemed impractical by some manufacturers, for the lights frequently generated excessive amounts of heat and also required lenses for evenly dispersing light.

To solve the problem in an alternative way, other automobile manufacturers have incorporated glow-in-the-dark material within the floor consoles of their vehicles. Over time, however, the use of such material too has been deemed largely impractical by some manufacturers, for such material often did not provide enough light for effectively illuminating a floor console.

In view of the above, there is a present need in the art for a low-level light source that can be installed within the floor console of an automotive vehicle for thereby effectively illuminating one or more features within the console at night.

### SUMMARY OF THE INVENTION

The present invention provides an illuminable feature module for installing in a console. In one practicable embodiment, the feature module includes an installable mount, a feature, a power inverter, and an illuminable electroluminescent wire. The feature is joined to the mount, and the power inverter is attached to the mount. The power inverter has both a power input and a power output. The electroluminescent wire is electrically connected to the power output of the power inverter. The electroluminescent wire is also fixedly arranged about the feature for thereby illuminating the feature. The mount, together with the feature, power inverter, and electroluminescent wire, is installable in a console.

The present invention also provides a control circuit for illuminating a feature in a console. The control circuit includes a power inverter and an illuminable electroluminescent wire. The power inverter has a power input, a control input, and a power output. The electroluminescent wire is electrically connected to the power output of the power inverter. The electroluminescent wire is arrangeable about the feature for thereby illuminating the feature.

In addition to the above, it is believed that various alternative embodiments, design considerations, applications, methodologies, and advantages of the present invention will become apparent to those skilled in the art when the detailed description of the best mode contemplated for practicing the present invention, as set forth hereinbelow, is reviewed in conjunction with the appended claims and the accompanying drawing figures.

### BRIEF DESCRIPTION OF THE DRAWINGS

The present invention is described hereinbelow, by way of example, with reference to the following drawing figures.

FIG. 1 illustrates a perspective view of an assembled floor console for an automotive vehicle. In this view, the floor console includes an illuminable feature module with two cupholders.

FIG. 2 illustrates a top perspective view of the illuminable feature module with two cupholders depicted in FIG. 1.

FIG. 3 illustrates a bottom perspective view of the illuminable feature module with two cupholders depicted in FIGS. 1 and 2.

FIG. 4 illustrates a system diagram of a control circuit for illuminating the feature module with two cupholders depicted in FIGS. 1 through 3.

### DETAILED DESCRIPTION OF THE INVENTION

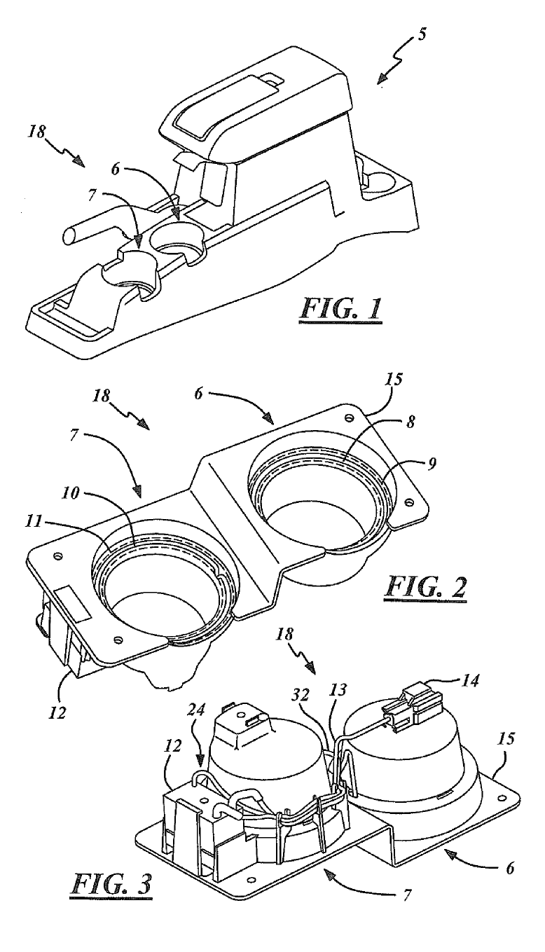

FIG. 1 illustrates a perspective view of a floor console assembly 5 for an automotive vehicle. In this view, the floor console assembly 5 is fully assembled and is shown to include an illuminable feature module 18. The feature module 18 includes two illuminable features, namely a first cupholder 6 and a second cupholder 7.

FIG. 2 illustrates a top perspective view of the illuminable feature module 18 depicted in FIG. 1. In this view, the feature module 18 is shown to include an installable mount 15, the first cupholder 6, the second cupholder 7, a DC-to-AC power inverter 12, a first illuminable electroluminescent wire 8, a first light-diffusing translucent cover 9, a second illuminable electroluminescent wire 10, and a second light-diffusing translucent cover 11.

As further illustrated in FIG. 2, both the first cupholder 6 and the second cupholder 7 are integrally joined to the installable mount 15. In other possible embodiments, however, such features may alternatively be merely attached or affixed to such a mount. Moreover, as also illustrated in FIG. 2, the DC-to-AC power inverter 12 is attached to the mount 15 as well. Though such a power inverter may be attached to other sections of such a mount in alternative embodiments, the power inverter 12 is attached to the underside of the mount 15 in FIG. 2. Furthermore, as shown, the first electroluminescent wire 8 is fixedly arranged in and/or about the first cupholder 6 for thereby illuminating the cupholder 6. In a similar fashion, the second electroluminescent wire 10 is fixedly arranged in and/or about the second cupholder 7 for thereby illuminating the cupholder 7 as well. Within such a configuration, the first translucent cover 9 is fixedly situated so as to at least partially cover the first electroluminescent wire 8. Similarly, the second translucent cover 11 is fixedly situated so as to at least partially cover the second electroluminescent wire 10. Though other light-diffusing materials in alternative embodiments may be utilized to cover such electroluminescent wires, both the first translucent cover 9 and the second translucent cover 11 in FIG. 2 are made of a plastic material such as, for example, un-colored polypropylene.

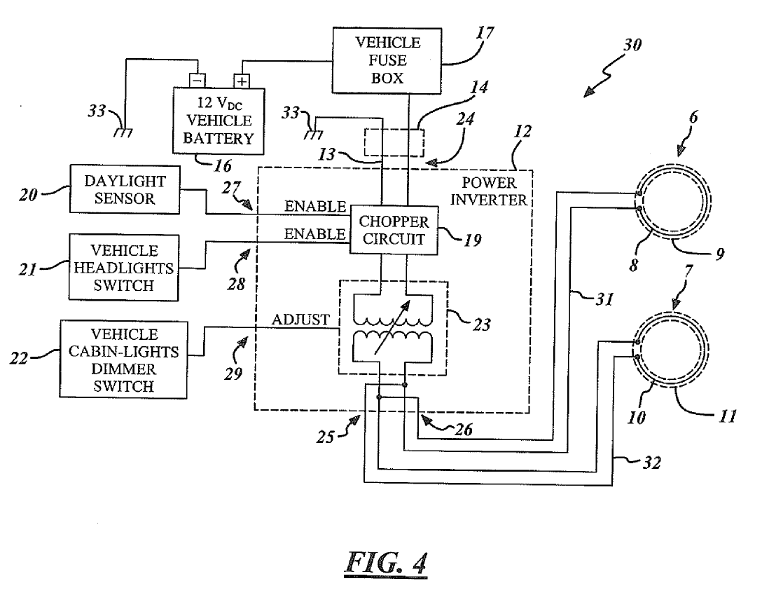

FIG. 3 illustrates a bottom perspective view of the illuminable feature module 18 depicted in FIGS. 1 and 2. As shown in this view, the feature module 18 also includes an electrical connector 14 that is attached to the mount 15. Though such an electrical connector may be attached to other sections of such a mount in alternative embodiments, the electrical connector 14 is attached to the underside of the mount 15 in FIG. 3. Moreover, as further shown in both this view and FIG. 4, the power inverter 12 has one power input 24 and two power outputs 25 and 26. The power input 24 of the power inverter 12, first of all, is electrically connected to the electrical connector 14 with an insulated pair of wires 13. The power output 26 of the power inverter 12, in turn, is electrically connected to the two electrodes of the first electroluminescent wire 8 with an insulated pair of wires 31. In a similar fashion, the power output 25 of the power inverter 12 is electrically connected to the two electrodes of the second electroluminescent wire 10 with an insulated pair of wires 32. Though the power inverter 12 has two power outputs 25 and 26 in FIGS. 3 and 4, such a power inverter may generally have any number of power inputs in alternative embodiments.

FIG. 4 illustrates a system diagram of a control circuit 30 for illuminating the feature module 18 depicted in FIGS. 1 through 3. As illustrated, the control circuit 30 includes the electrical connector 14, the DC-to-AC power inverter 12, the first electroluminescent wire 8, and the second electroluminescent wire 10, all electrically connected as described hereinabove. In addition, the control circuit 30 further includes a 12-volt direct-current (DC) vehicle battery 16 that is electrically connected to the power input 24 of the power inverter 12 via both a vehicle fuse box 17 and the electrical connector 14. In general, the vehicle battery 16 serves as a power source for illuminating both the first electroluminescent wire 8 and the second electroluminescent wire 10. Though the 12-volt DC vehicle battery 16 is included in the control circuit 30 shown in FIG. 4, other power sources may alternatively be included in such a control circuit in other embodiments.

As further illustrated in FIG. 4, the power inverter 12 itself includes both a chopper circuit 19 and a transformer 23 that are electrically connected between the power input 24 and the power outputs 25 and 26 of the power inverter 12. To facilitate better control in illuminating both the first electroluminescent wire 8 and the second electroluminescent wire 10, the power inverter 12 may additionally include one or more control inputs 27, 28, and 29. As shown in FIG. 4, such control inputs may include electrical signals received from, for example, a daylight sensor 20, a manipulable vehicle headlights switch 21, or a manipulable vehicle cabin-lights dimmer switch 22, which is onboard an automotive vehicle. Depending on a given embodiment of the control circuit 30, any such control input may or may not require the power inverter 12 to have a separate physical connector therefor in addition to the electrical connector 14 associated with its power input 24.

During operation of the control circuit 30, the vehicle battery 16 supplies approximately 12 volts of DC voltage (i.e., electrical power) to the power input 24 of the power inverter 12 via both the vehicle fuse box 17 and the electrical connector 14. Upon being supplied with such DC voltage, the chopper circuit 19 of the power inverter 12 then operates to interrupt the supply of the DC voltage at a predetermined frequency or rate so as to produce alternating-current (AC) voltage. To ensure that any AC voltage ultimately supplied to the first electroluminescent wire 8 and the second electroluminescent wire 10 is not excessive, the AC voltage produced by the chopper circuit 19 is electrically communicated to the transformer 23 wherein the AC voltage is reduced to a predetermined level ranging, for example, from about 2 volts to 5 volts of AC voltage. After the AC voltage is reduced, the AC voltage is electrically communicated to the respective electrodes of both the first electroluminescent wire 8 and the second electroluminescent wire 10. Upon being ultimately supplied with such AC voltage, the electroluminescent wire 8 and the electroluminescent wire 10 are thereby illuminated and give off a predetermined color such as, for example, blue or green. During such illumination, the first and second translucent covers 9 and 11 respectively situated over the first and second electroluminescent wires 8 and 10 serve to evenly diffuse the light that is emitted from the wires 8 and 10.

As mentioned hereinabove, the power inverter 12 may additionally include one or more control inputs 27, 28, and 29 to thereby facilitate better control in illuminating the first electroluminescent wire 8 and the second electroluminescent wire 10 during operation of the control circuit 30. Thus, if in one embodiment the power inverter 12 is adapted to receive an electrical signal as a control input 27 from the daylight sensor 20 onboard a vehicle, the power inverter 12 is thereby effectively enabled or disabled depending on the level of light sensed by the daylight sensor 20. In this way, the first and second electroluminescent wires 8 and 10 respectively associated with the first and second cupholders 6 and 7 are automatically illuminated during the night and also turned off during the day. Furthermore, if in another embodiment the power inverter 12 is adapted to receive an electrical signal as a control input 29 from the cabin-lights dimmer switch 22 onboard a vehicle, the power inverter 12 effectively adjusts the level of the AC voltage produced by the transformer 23 according to the dimmer switch's manipulated position. In this way, the precise illumination levels of the first and second electroluminescent wires 8 and 10 are controlled during the night.

Though cupholders are shown to be included as features in the illuminable feature module 18 depicted in FIGS. 1 through 4 hereinabove, it is to be understood that other features may alternatively be included in such a module in other embodiments. In a vehicle's floor console, such other features may include, for example, an ashtray or some sort of storage bin. Furthermore, in a vehicle's dashboard console, such other features may even include, for example, a glove compartment, a clock, a speedometer, an odometer, a gas gauge, a temperature gauge, a digital display, a vent, a manipulable dial, a manipulable switch, a pressable button, a radio, a speaker, a keypad, a touch pad, a trackball, or a monitor screen.

In summary, by incorporating electroluminescent wires instead of light bulbs and glow-in-the-dark materials in a vehicle console to thereby illuminate one or more features in the console at night, many advantages are thereby realized. Some of these advantages include flexibility, durability, the generation of negligible levels of heat, and the generation of sufficient levels of light for illuminating console features while at the same time not interfering with a driver's nighttime road vision.

### List of Parts and Features

To facilitate a proper understanding of the present invention, a list of parts and features lighted with alphanumeric designations in FIGS. 1 through 4 is set forth hereinbelow.
5 floor console assembly
6 first cupholder (i.e., feature)
7 second cupholder (i.e., feature)
8 first illuminable electroluminescent wire
9 first light-diffusing translucent cover
10 second illuminable electroluminescent wire
11 second light-diffusing translucent cover
12 DC-to-AC power inverter
13 insulated pair of wires
14 electrical connector
15 installable mount
16 12-volt DC vehicle battery (i.e., power source)
17 vehicle fuse box
18 illuminable feature module
19 chopper circuit
20 daylight sensor
21 vehicle headlights switch
22 vehicle cabin-lights dimmer switch
23 transformer (optionally variable)
24 power input
25 power output
26 power output
27 control input (enable)
28 control input (enable)
29 control input (adjust)
30 control circuit
31 insulated pair of wires
32 insulated pair of wires
33 chassis ground

While the present invention has been described in what are presently considered to be its most practical and preferred embodiments or implementations, it is to be understood that the invention is not to be limited to the particular embodiments disclosed hereinabove. On the contrary, the present invention is intended to cover various modifications and equivalent arrangements included within the spirit and scope of the claims appended hereinbelow, which scope is to be accorded the broadest interpretation so as to encompass all such modifications and equivalent structures as are permitted under the law.

What is claimed is:

1. An illuminable feature module for installing in a console, said feature module comprising:
an installable mount;
a feature joined to said mount;
a power inverter attached to said mount and having both a power input and a power output; and
an illuminable electroluminescent wire fixedly arranged about said feature and electrically connected to said power output of said power inverter.

2. An illuminable feature module according to claim 1, wherein said feature includes at least one item selected from the group consisting of an ashtray, a cupholder, and a storage bin.

3. An illuminable feature module according to claim 1, wherein said feature module further comprises an electrical connector attached to said mount and electrically connected to said power input of said power inverter.

4. An illuminable feature module according to claim 1, wherein said power inverter has a control input.

5. An illuminable feature module according to claim 4, wherein said control input is adapted for being electrically connected to at least one control device selected from the group consisting of a vehicle headlights switch, a vehicle cabin-lights dimmer switch, and a light sensor.

6. An illuminable feature module according to claim 1, wherein said feature module further comprises a light-diffusing translucent cover over said electroluminescent wire.

7. An illuminable feature module according to claim 6, wherein said translucent cover comprises plastic.

8. An illuminable feature module for installing in a console within a vehicle, said feature module comprising:
an installable mount;
a feature joined to said mount;
a power inverter attached to said mount and having both a power input and a power output; and
an illuminable electroluminescent wire fixedly arranged about said feature and electrically connected to said power output of said power inverter;
wherein said feature includes at least one item selected from the group consisting of an ashtray, a cupholder, and a storage bin.

9. A control circuit for illuminating a feature in a console, said control circuit comprising:
a power inverter having a power input, a control input, and a power output; and
an illuminable electroluminescent wire electrically connected to said power output of said power inverter;
wherein said electroluminescent wire is arrangeable about said feature for illuminating said feature.

10. A control circuit according to claim 9, wherein said feature includes at least one item selected from the group consisting of an ashtray, a cupholder, a storage bin, a glove compartment, a clock, a speedometer, an odometer, a gas gauge, a temperature gauge, a digital display, a vent, a manipulable dial, a manipulable switch, a pressable button, a radio, a speaker, a keypad, a touch pad, a trackball, and a monitor screen.

11. A control circuit according to claim 9, wherein said control circuit further comprises a power source electrically connected to said power input of said power inverter.

12. A control circuit according to claim 11, wherein said power source includes a battery.

13. A control circuit according to claim 9, wherein said control circuit further comprises a vehicle fuse box electrically connected to said power input of said power inverter.

14. A control circuit according to claim 9, wherein said power inverter includes a chopper circuit and a transformer electrically connected between said power input and said power output of said power inverter.

15. A control circuit according to claim 9, wherein said power inverter includes a variable transformer electrically connected between said power input, said control input, and said power output of said power inverter.

16. A control circuit according to claim 15, wherein said control circuit further comprises a vehicle cabin-lights dimmer switch electrically connected to said control input of said power inverter.

17. A control circuit according to claim 9, wherein said control circuit further comprises a manipulable switch electrically connected to said control input of said power inverter.

18. A control circuit according to claim 17, wherein said manipulable switch is a vehicle headlights switch or a vehicle cabin-lights dimmer switch.

19. A control circuit according to claim 9, wherein said control circuit further comprises a light sensor electrically connected to said control input of said power inverter.

20. A control circuit according to claim 9, wherein said control input coincides with said power input.
